(19) United States
(12) Patent Application Publication
(10) Pub. No.: US 2023/0036666 A1
(43) Pub. Date: Feb. 2, 2023

(54) SELECTING AN INTERFACE FOR SELECTING QUANTITIES OF AN ITEM BASED ON INFORMATION ABOUT THE ITEM ACCESSIBLE BY AN ONLINE CONCIERGE SYSTEM

(71) Applicant: Maplebear Inc. (dba Instacart), San Francisco, CA (US)

(72) Inventors: Yilena Xu, Berkeley, CA (US); Qingyuan Chen, San Francisco, CA (US); Laurentia Romaniuk, San Francisco, CA (US); Jonathan Newman, Menlo Park, CA (US); Josh Roberts, San Francisco, CA (US); Conor Woods, Berkeley, CA (US); Lorna Qin, San Francisco, CA (US)

(21) Appl. No.: 17/387,943

(22) Filed: Jul. 28, 2021

(51) Int. Cl. G06Q 30/06; G06Q 30/02

(52) U.S. Cl. CPC G06Q 30/0627; G06Q 30/0641; G06Q 30/0613; G06Q 30/0283; G06Q 30/0633

(57) ABSTRACT

An online concierge system offers items for sale and uses different units of measurements for items, allowing users to purchase numbers of an item, a weight of an item, or a packages of an item. To avoid confusing users with multiple options for specifying a quantity of an item, the online concierge system determines whether to present an interface for purchasing an item by a number of the item, by weight of the item, or a number of packages in the item from dynamic information about the item. For example, the online concierge system obtains historical pricing information an items and computes a par-weight price for the item from prior purchases of the item. The online concierge system uses the par-weight of the item to select an interface for a user when purchasing the item.

### BACKGROUND

This disclosure relates generally to ordering an item through an online concierge system, and more specifically to selecting an interface for selecting a quantity of an item for inclusion in an order via the online concierge system.

In current online concierge systems, shoppers (or “pickers”) fulfill orders at a physical warehouse, such as a retailer, on behalf of users as part of an online shopping concierge service. An online concierge system provides an interface to a user identifying items offered by a physical warehouse and receives selections of one or more items for an order from the user. In current online concierge systems, the shoppers may be sent to various warehouses with instructions to fulfill orders for items, and the shoppers then find the items included in the user order in a warehouse.

To place an order through a conventional online concierge system, users select items from a client device through one or more interfaces communicated to the client device by the online concierge system. Different items available for purchase through the online concierge system use different units of measurement for specifying quantity. To order certain items, a user specifies a number of units of the item to purchase, while for other items, the user specifies a weight of the item to purchase. For some items, a warehouse offering an item uses a different unit of measurement for quantities of an item than how an interface of the online concierge system allows users to specify quantities of the item. For example, a warehouse sells variable weight items, such as packaged meat or seafood, by weight, while conventional online concierge systems allow users to select a number of packages of a variable weight item. Such difference between specification of units of measurement for quantities of items between warehouses and conventional online concierge systems makes it difficult for users to ascertain a quantity of certain items ordered via an online concierge system.

Conventional online concierge systems display options for certain items allowing a user to specific a number of units of an item or a weight of the item to purchase. However, such an option confuses a number of users, leading to inaccurate specification of a quantity of items purchased for the user. This causes users to receive a different amount of an item than expected, reducing subsequent interaction with the online concierge system by the users.

### SUMMARY

An online concierge system obtains information about an item offered by a warehouse. In various embodiments, the online concierge system receives a set of information about the item from the warehouse and maintains additional information associated with the item determined by the online concierge system. This allows the online concierge system to combine descriptive information about the item from a warehouse with additional information generated by the online concierge system about the item, such as information generated from prior purchases of the item by the users of the online concierge system. In various embodiments, the information about the item includes quantity selection information for the item. A portion of the quantity selection information may be provided by the warehouse from which the item is to be obtained, while one or more other portions of the quantity selection information is generated by the online concierge system from prior purchases of the item, as further described below. In some embodiments, the online concierge system obtains the information about the item in response to a user selecting a warehouse for an order, with the information about the item included in an item catalog of items offered by the warehouse for purchase. In other embodiments, the online concierge system obtains the information about the item when the user selects the item after selecting a warehouse from which one or more items of an order are to be purchased.

To allow a user to more easily specify a quantity of the item to be purchased for an order, the online concierge system uses quantity selection information for the item to select an interface for presentation to the user. The online concierge system maintains different interfaces for different quantity selection information, allowing different interfaces displaying different units of measurement for specifying a quantity of the item for inclusion in an order based on quantity selection information for the item. Such selection of a unit or measurement-specific interface for including the item in an order prevents confusion or ambiguity by a user when identifying a quantity of the item for inclusion in an order, while simplifying selection of a quantity by preventing the user from providing both a quantity of the item for inclusion in the order and a unit of measurement for the quantity.

The online concierge system determines whether quantity selection information obtained for the item specifies a cost per unit for the item. In various embodiments, the quantity selection information includes a specific value if a cost per unit is specified for the item and includes an alternative value if a cost per weight is specified for the item. A warehouse from which the item is obtained (e.g., a warehouse selected by the user for an order) includes the specific value in the obtained information for the item in various embodiments, allowing the warehouse to indicate whether the item is priced per unit. In response to determining that the quantity selection information for the item specifies a cost per unit for the item, the online concierge system configures a selection element of an interface to receive a number of the item to include in an order. To simplify specification of the quantity of the item, the selection element of the interface includes only a unit of measurement corresponding to a number of items in various embodiments, removing ambiguity for the user about the unit of measurement used to specify the quantity of the item. The online concierge system transmits the interface with the selection element configured to receive the number of the item to a client device of the user for display.

In response to determining that that the quantity selection information for the item specifies a cost per weight for the item, the online concierge system determines whether the item is an item limited to being sold by weight. To determine whether the item is limited to being sold by weight, the online concierge system maintains a set of items for sale by weight only and compares an identifier of the item to identifiers of items of the set. In various embodiments, the set of items for sale by weight only is generated from manual review of items offered for sale and identification of items for which it is impractical to sell using a unit of measurement other than weight. Alternatively, the online concierge system may generate the set from prior purchases of items, with items for which at least a threshold percentage of prior orders for the item specified a quantity of the item using weight. The online concierge system may maintain different sets of items for sale by weight only for different warehouses and may include items in a set of items for sale by weight only for a warehouse based on information identifying the items from the warehouse.

In response to determining that the item is limited to being sold by weight from the quantity selection information for the item, the online concierge system configures a selection element of the interface to receive a weight of the item to include in an order. To simplify specification of the quantity of the item, the selection element of the interface includes only a unit of measurement corresponding to a weight of items in various embodiments, removing ambiguity for the user about the unit of measurement used to specify the quantity of the item. The online concierge system transmits the interface with the selection element configured to receive the weight of the item to a client device of the user for display.

However, in response to determining that the item is not limited to being sold by weight, the online concierge system determines whether a par weight for the item is included in the quantity selection information for the item. The par weight is determined from previously fulfilled orders for the item and specifies a weight of a single item from previously purchased numbers of items and weights corresponding to the previously purchased numbers of item; hence, the par weight provides a weight per individual item from fulfillment of orders identifying the item. The online concierge system determines a par weight for the item from previously fulfilled orders for the item. When an order identifies an item and a weight of the item to purchase, when a shopper fulfills the order, the online concierge system requests the shopper identify the weight of the item that was obtained by the shopper and a number of the items that were obtained by the shopper. For example, the online concierge system transmits a prompt to a client device of the shopper to identify a number of the item that were obtained when fulfilling the order via a shopper mobile application and transmits an additional prompt to the client device of the shopper to identify a weight of the item that was obtained when fulfilling the order via the shopper mobile application. The online concierge system determines the par weight for the item for a fulfilled order by dividing the weight of the item obtained when fulfilling the order by the number of items obtained when fulfilling the order. The par weight of the item is determined from a set of fulfilled orders for which the item was obtained; for example, the online concierge system determines the par weight of the item from par weights for the item for each of a set of orders fulfilled within a threshold amount of a current time determines the par weight for the item from par weights for the item for each of a threshold number of orders received within a threshold amount of time from a current time. This allows the online concierge system to dynamically update the par weight for the item as the item is purchased over time. Alternatively, the warehouse transmits a specific par weight for the item to the online concierge system for storage in association with a combination of the item and the warehouse; the warehouse may transmit the specific par weight for the item at periodic intervals in various embodiments.

In response to determining that a par weight is not stored for the item, the online concierge system configures the selection element of the interface to receive the weight of the item. The online concierge system transmits the interface with the selection element configured to receive the weight of the item to a client device of the user for display.

However, in response to determining that a par weight is stored for the item, the online concierge system determines whether the item is offered in a package including one or more items. Whether the item is offered in a package is based on prior orders from data determined from previously fulfilled orders in which the item was obtained and stored in association with the item. In various embodiments, the online concierge system prompts a shopper who obtained the item for an order to indicate whether the item was included in a package through a shopper mobile application. This allows the online concierge system to account for purchases of the item by shoppers to determine if the item is included in a package. In various embodiments, the online concierge system stores a package value in association with the item in response to receiving an indication that the item was included in a package from in a threshold number of previously fulfilled orders including the item. For example, the online concierge system stores an indication the item is included in a package if at least a threshold percentage of orders fulfilled within a threshold amount of a current time include an indication from a shopper that the item was included in a package. In some embodiments, the online concierge system stores an indication the item is included in a package in association with the item and with a warehouse, allowing the online concierge system to maintain different indications of the item being included in a package, determined as further described above, for different warehouses, allowing the online concierge system to account for potential differences in packaging of the item by different warehouses. In some embodiments, the online concierge system stores an alternative value in association with the item indicating the item is not included in a package in response to receiving a threshold number, or a threshold amount, of indications from shoppers fulfilling orders that the item is not included in a package; for example, in response to receiving an indication from shoppers for a threshold number of previously fulfilled orders including the item that the item is not included in a package, the online concierge system stores the alternative value indicating the item is not included in a package in association with the item. In some embodiments, the online concierge system does not store a value indicating whether the item is included in a package when less than the threshold number or amount of indications whether the item is included in a package are received from shoppers fulfilling orders including the item, so the online concierge system does not maintain an indication whether the item is included in a package until receiving a minimum number of indications from shoppers whether the item is included in a package in some embodiments.

In response to determining that the item is included in a package (e.g., determining that a value indicating the item is included in a package is stored in association with the item from the obtained information), the online concierge system configures the interface to including information describing the item and configures the selection element of the interface to receive a number of packages of the item to include in an order. To simplify specification of the quantity of the item, the quantity selection element interface includes only a unit of measurement corresponding to a number of packages of the item in various embodiments, removing ambiguity for the user about the unit of measurement used to specify the quantity of the item. The online concierge system transmits the interface with the selection element configured to receive a number of packages of the item to a client device of the user for display.

In response to determining that an alternative value indicating the item is not included in a package is stored in association with the item from the obtained information, the online concierge system configures the selection element of the interface to receive a number of the item for inclusion in an order, as further described above. Hence, if the obtained information for the item indicates the item is not included in a package, the online concierge system configures the selection element of the interface to receive a quantity of the item for inclusion in the order.

In response to determining no value indicating whether the item is included in a package or is not included in a package, the online concierge system determines a category of the item from the obtained information for the item. In various embodiments, the online concierge system associates a category with each item offered by a warehouse. The category may be specified by the warehouse from which the item is to be obtained, while in some embodiments the online concierge system maintains a mapping of categories identified by a warehouse to categories maintained by the online concierge system to provide standardization of categories for items across various warehouses. For each of at least a set of categories, the online concierge system maintains an association between a category and a selection element of an interface for specifying a quantity of an item associated with the category. For example, the online concierge system stores an association between a category of produce and a selection element configured to receive a number of items, while the online concierge system stores an association between a category of meat and a selection element configured to receive a weight of the item. However, in other embodiments, the online concierge system stores an association between any suitable configuration of a selection element and a category. The stored association between a configuration of the selection element and a category of item allows the online concierge system to specify a default configuration of the selection element of an interface for items having the category that is displayed when the online concierge system does not maintain information associated with the item indicating whether the item is included in a package. The online concierge system selects a configuration of the selection element of the interface based on the category associated with the item and transmits the interface with the selected configuration for the selection element to a client device of the user for display. Hence, based on the category determined for the item, the online concierge system selects a configuration of the selection element of the interface of the set consisting of: a configuration to receive a number of the item, a configuration to receive a weight of the item, and a configuration to receive a number of packages of the item and transmits the interface with the selected configuration of the selection element to the client device of the user for display.

### BRIEF DESCRIPTION OF THE DRAWINGS

FIG. 1 illustrates an environment of an online shopping concierge service, according to one embodiment.

FIG. 2 is a diagram of an online shopping concierge system, according to one embodiment.

FIG. 3A is a diagram of a customer mobile application (CMA), according to one embodiment.

FIG. 3B is a diagram of a shopper mobile application (SMA), according to one embodiment.

FIG. 4 is a flowchart of a method for an online concierge system selecting an interface for a user to specify a quantity of an item for inclusion in an order, according to one embodiment.

FIG. 5 is an example interface configured to receive a number of an item for display to a user by an online concierge system, in accordance with an embodiment.

FIG. 6 is an example interface configured to receive a weight of an item for display to a user by an online concierge system, in accordance with an embodiment.

FIG. 7 is an example interface configured to receive a number of packages of an item for display to a user by an online concierge system, in accordance with an embodiment.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Overview

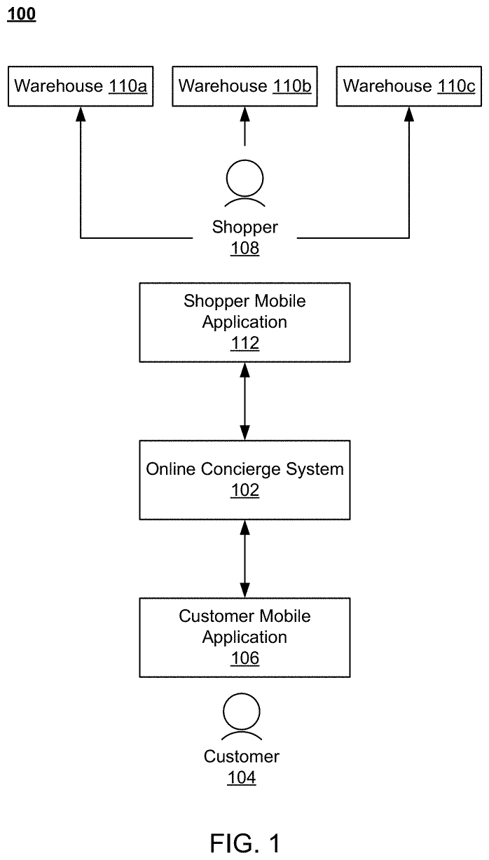

FIG. 1.i illustrates an environment 100 of an online platform, according to one embodiment. The figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral. For example, “110” in the text refers to reference numerals “110a” and/or “110b” in the figures.

The environment 100 includes an online concierge system 102. The system 102 is configured to receive orders from one or more users 104 (only one is shown for the sake of simplicity). An order specifies a list of goods (items or products) to be delivered to the user 104. The order also specifies the location to which the goods are to be delivered, and a time window during which the goods should be delivered. In some embodiments, the order specifies one or more retailers from which the selected items should be purchased. The user may use a customer mobile application (CMA) 106 to place the order; the CMA 106 is configured to communicate with the online concierge system 102.

The online concierge system 102 is configured to transmit orders received from users 104 to one or more shoppers 108. A shopper 108 may be a contractor, employee, other person (or entity), robot, or other autonomous device enabled to fulfill orders received by the online concierge system 102. The shopper 108 travels between a warehouse and a delivery location (e.g., the user's home or office). A shopper 108 may travel by car, truck, bicycle, scooter, foot, or other mode of transportation. In some embodiments, the delivery may be partially or fully automated, e.g., using a self-driving car. The environment 100 also includes three warehouses 110a, 110b, and 110c (only three are shown for the sake of simplicity; the environment could include hundreds of warehouses). The warehouses 110 may be physical retailers, such as grocery stores, discount stores, department stores, etc., or non-public warehouses storing items that can be collected and delivered to users. Each shopper 108 fulfills an order received from the online concierge system 102 at one or more warehouses 110, delivers the order to the user 104, or performs both fulfillment and delivery. In one embodiment, shoppers 108 make use of a shopper mobile application 112 which is configured to interact with the online concierge system 102.

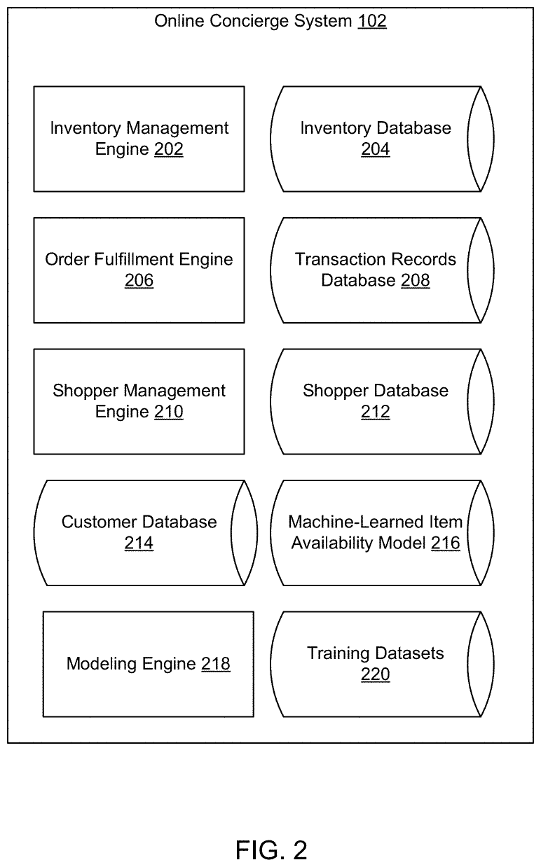

FIG. 2 is a diagram of an online concierge system 102, according to one embodiment. The online concierge system 102 includes an inventory management engine 202, which interacts with inventory systems associated with each warehouse 110. In one embodiment, the inventory management engine 202 requests and receives inventory information maintained by the warehouse 110. The inventory of each warehouse 110 is unique and may change over time. The inventory management engine 202 monitors changes in inventory for each participating warehouse 110. The inventory management engine 202 is also configured to store inventory records in an inventory database 204. The inventory database 204 may store information in separate records—one for each participating warehouse 110—or may consolidate or combine inventory information into a unified record. Inventory information includes both qualitative and qualitative information about items, including size, color, weight, SKU, serial number, and so on. In one embodiment, the inventory database 204 also stores purchasing rules associated with each item, if they exist. For example, age-restricted items such as alcohol and tobacco are flagged accordingly in the inventory database 204. Additional inventory information useful for predicting the availability of items may also be stored in the inventory database 204. For example, for each item-warehouse combination (a particular item at a particular warehouse), the inventory database 204 may store a time that the item was last found, a time that the item was last not found (a shopper looked for the item but could not find it), the rate at which the item is found, and the popularity of the item.

In various embodiments, the inventory management engine 202 maintains a taxonomy of items offered for purchase by one or more warehouses 110. For example, the inventory management engine 202 receives an item catalog from a warehouse 110 identifying items offered for purchase by the warehouse 110. From the item catalog, the inventory management engine 202 determines a taxonomy of items offered by the warehouse 110. different levels in the taxonomy providing different levels of specificity about items included in the levels. In various embodiments, the taxonomy identifies a generic item description and associates one or more specific items with the generic item identifier. For example, a generic item description identifies “milk,” and the taxonomy associates identifiers of different milk items (e.g., milk offered by different brands, milk having one or more different attributes, etc.), with the generic item identifier. Thus, the taxonomy maintains associations between a generic item description and specific items offered by the warehouse 110 marching the generic item description. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a generic item description, while items in higher levels of the hierarchical taxonomy have a fewer number of attributes, corresponding to less specificity in a generic item description. In various embodiments, higher levels in the taxonomy include less detail about items, so greater numbers of items are included in higher levels (e.g., higher levels include a greater number of items satisfying a broader generic item description). Similarly, lower levels in the taxonomy include greater detail about items, so fewer numbers of items are included in the lower levels (e.g., higher levels include a fewer number of items satisfying a more specific generic item description). The taxonomy may be received from a warehouse 110 in various embodiments. In other embodiments, the inventory management engine 202 applies a trained classification module to an item catalog received from a warehouse 110 to include different items in levels of the taxonomy, so application of the trained classification model associates specific items with generic item descriptions corresponding to levels within the taxonomy.

Inventory information provided by the inventory management engine 202 may supplement the training datasets 220. Inventory information provided by the inventory management engine 202 may not necessarily include information about the outcome of picking a delivery order associated with the item, whereas the data within the training datasets 220 is structured to include an outcome of picking a delivery order (e.g., if the item in an order was picked or not picked).

The online concierge system 102 also includes an order fulfillment engine 206 which is configured to synthesize and display an ordering interface to each user 104 (for example, via the customer mobile application 106). The order fulfillment engine 206 is also configured to access the inventory database 204 in order to determine which products are available at which warehouse 110. The order fulfillment engine 206 may supplement the product availability information from the inventory database 204 with an item availability predicted by the machine-learned item availability model 216. The order fulfillment engine 206 determines a sale price for each item ordered by a user 104. Prices set by the order fulfillment engine 206 may or may not be identical to in-store prices determined by retailers (which is the price that users 104 and shoppers 108 would pay at the retail warehouses). The order fulfillment engine 206 also facilitates transactions associated with each order. In one embodiment, the order fulfillment engine 206 charges a payment instrument associated with a user 104 when he/she places an order. The order fulfillment engine 206 may transmit payment information to an external payment gateway or payment processor. The order fulfillment engine 206 stores payment and transactional information associated with each order in a transaction records database 208.

In some embodiments, the order fulfillment engine 206 also shares order details with warehouses 110. For example, after successful fulfillment of an order, the order fulfillment engine 206 may transmit a summary of the order to the appropriate warehouses 110. The summary may indicate the items purchased, the total value of the items, and in some cases, an identity of the shopper 108 and user 104 associated with the transaction. In one embodiment, the order fulfillment engine 206 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 206, which provides detail of all orders which have been processed since the last request.

The order fulfillment engine 206 may interact with a shopper management engine 210, which manages communication with and utilization of shoppers 108. In one embodiment, the shopper management engine 210 receives a new order from the order fulfillment engine 206. The shopper management engine 210 identifies the appropriate warehouse to fulfill the order based on one or more parameters, such as a probability of item availability determined by a machine-learned item availability model 216, the contents of the order, the inventory of the warehouses, and the proximity to the delivery location. The shopper management engine 210 then identifies one or more appropriate shoppers 108 to fulfill the order based on one or more parameters, such as the shoppers' proximity to the appropriate warehouse 110 (and/or to the user 104), his/her familiarity level with that particular warehouse 110, and so on. Additionally, the shopper management engine 210 accesses a shopper database 212 which stores information describing each shopper 108, such as his/her name, gender, rating, previous shopping history, and so on.

As part of fulfilling an order, the order fulfillment engine 206 and/or shopper management engine 210 may access a user database 214 which stores information describing each user. This information could include each user's name, address, gender, shopping preferences, favorite items, stored payment instruments, and so on.

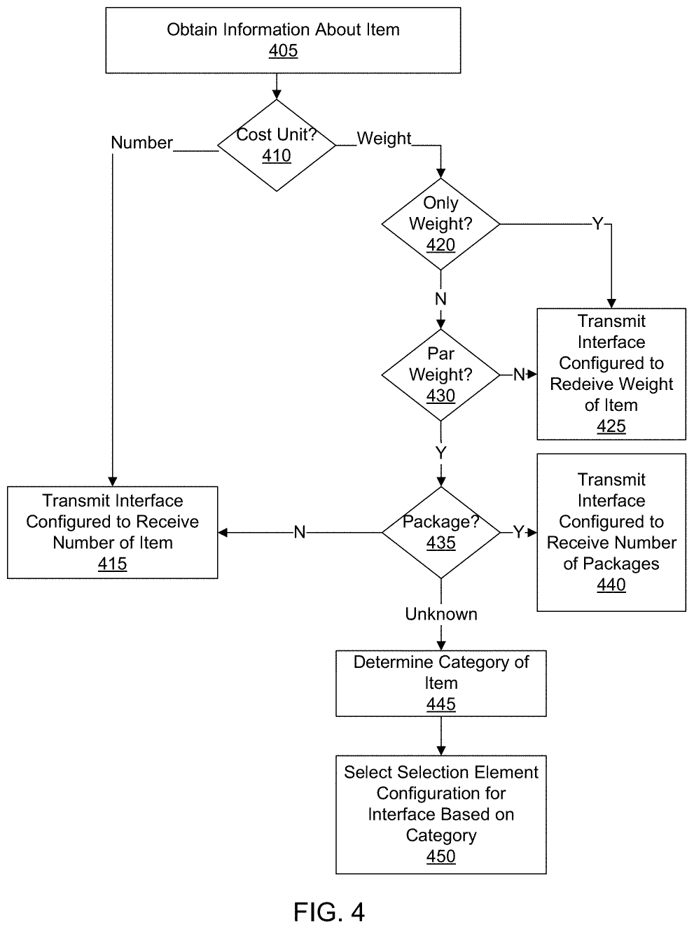

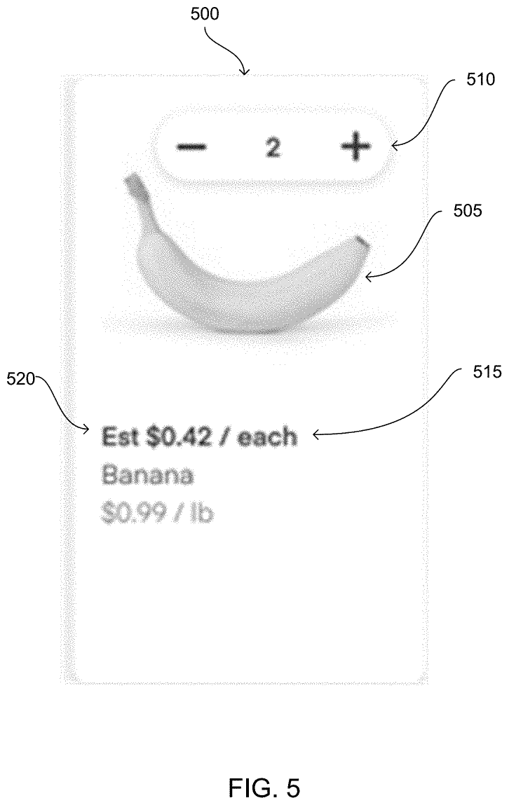

In various embodiments, the order fulfillment engine 206 leverages a taxonomy of items maintained by the inventory management engine 202 to simplify order creation for a user. In various embodiments, the order fulfillment engine 206 receives a generic item description for inclusion in an order from a user and selects a generic item description from a taxonomy maintained for a warehouse 110 identified by the order, as further described below in conjunction with FIGS. 4 and 5. From the taxonomy, the order fulfillment engine 206 selects a set of items associated with the received generic item description. As further described below in conjunction with FIGS. 4 and 5, the order fulfillment engine 206 selects an item from the set of items based on one or more criteria. For example, the order fulfillment engine 206 applies a trained purchase model to each item of the set, determining a probability of the user purchasing each item of the set. Based on the determined probabilities, the order fulfillment engine 206 selects an item from the set. The order fulfillment engine 206 generates an interface for display to the user, such as through the customer mobile application 106 that is populated with information identifying the selected item, simplifying inclusion of an item in the order by allowing information identifying the order to include a generic description of an item, from which the order fulfillment engine 206 selects a specific item for inclusion in the order. This simplifies input provided by the user to create an order.

In various embodiments, the order fulfillment engine 206 maintains different interfaces for display to a user, with each of the interfaces corresponding to specification of a different unit of measurement for a quantity of items to include in an order. As further described below in conjunction with FIGS. 4-7, to simplify placement of an order by a user, the order fulfillment engine 206 selects an interface for display to identify an item based on quantity selection information for the item. In various embodiments, the quantity selection information provides information for determining a unit of measurement for specifying a quantity of the item to include in an order. For example, the quantity selection information allows the order fulfillment engine 206 to determine whether a quantity of an item is specified by a number of the item, by a weight of the item, or by a package of the item and select a specific interface for receiving the number of the item, the weight of the item, or a number of packages of the item, as further described below in conjunction with FIGS. 4-7. Different interfaces are configured to receive a corresponding specific unit of measurement for an item and not to receive alternative units of measurement for the item. Hence, rather than specify both a quantity and a unit of measurement for an item in an interface for including an item in an order, the order fulfillment engine 206 selects and displays a specific interface for different units of measurement to allow a user to more clearly identify a quantity of the item.

### Machine Learning Models

The online concierge system 102 further includes a machine-learned item availability model 216, a modeling engine 218, and training datasets 220. The modeling engine 218 uses the training datasets 220 to generate the machine-learned item availability model 216. The machine-learned item availability model 216 can learn from the training datasets 220, rather than follow only explicitly programmed instructions. The inventory management engine 202, order fulfillment engine 206, and/or shopper management engine 210 can use the machine-learned item availability model 216 to determine a probability that an item is available at a warehouse 110. The machine-learned item availability model 216 may be used to predict item availability for items being displayed to or selected by a user or included in received delivery orders. A single machine-learned item availability model 216 is used to predict the availability of any number of items.

The machine-learned item availability model 216 can be configured to receive as inputs information about an item, the warehouse for picking the item, and the time for picking the item. The machine-learned item availability model 216 may be adapted to receive any information that the modeling engine 218 identifies as indicators of item availability. At minimum, the machine-learned item availability model 216 receives information about an item-warehouse pair, such as an item in a delivery order and a warehouse at which the order could be fulfilled. Items stored in the inventory database 204 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 204. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 204 and/or warehouse database and provide this extracted information as inputs to the item availability model 216.

The machine-learned item availability model 216 contains a set of functions generated by the modeling engine 218 from the training datasets 220 that relate the item, warehouse, and timing information, and/or any other relevant inputs, to the probability that the item is available at a warehouse. Thus, for a given item-warehouse pair, the machine-learned item availability model 216 outputs a probability that the item is available at the warehouse. The machine-learned item availability model 216 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 216 includes a confidence score. The confidence score may be the error or uncertainty score of the output availability probability and may be calculated using any standard statistical error measurement. In some examples, the confidence score is based in part on whether the item-warehouse pair availability prediction was accurate for previous delivery orders (e.g., if the item was predicted to be available at the warehouse and not found by the shopper, or predicted to be unavailable but found by the shopper). In some examples, the confidence score is based in part on the age of the data for the item, e.g., if availability information has been received within the past hour, or the past day. The set of functions of the item availability model 216 may be updated and adapted following retraining with new training datasets 220. The machine-learned item availability model 216 may be any machine learning model, such as a neural network, boosted tree, gradient boosted tree or random forest model. In some examples, the machine-learned item availability model 216 is generated from XGBoost algorithm.

The item probability generated by the machine-learned item availability model 216 may be used to determine instructions delivered to the user 104 and/or shopper 108, as described in further detail below.

The training datasets 220 relate a variety of different factors to known item availabilities from the outcomes of previous delivery orders (e.g. if an item was previously found or previously unavailable). The training datasets 220 include the items included in previous delivery orders, whether the items in the previous delivery orders were picked, warehouses associated with the previous delivery orders, and a variety of characteristics associated with each of the items (which may be obtained from the inventory database 204). Each piece of data in the training datasets 220 includes the outcome of a previous delivery order (e.g., if the item was picked or not). The item characteristics may be determined by the machine-learned item availability model 216 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 216 may weight these factors differently, where the weights are a result of a “learning” or training process on the training datasets 220. The training datasets 220 are very large datasets taken across a wide cross section of warehouses, shoppers, items, warehouses, delivery orders, times and item characteristics. The training datasets 220 are large enough to provide a mapping from an item in an order to a probability that the item is available at a warehouse. In addition to previous delivery orders, the training datasets 220 may be supplemented by inventory information provided by the inventory management engine 202. In some examples, the training datasets 220 are historic delivery order information used to train the machine-learned item availability model 216, whereas the inventory information stored in the inventory database 204 include factors input into the machine-learned item availability model 216 to determine an item availability for an item in a newly received delivery order. In some examples, the modeling engine 218 may evaluate the training datasets 220 to compare a single item's availability across multiple warehouses to determine if an item is chronically unavailable. This may indicate that an item is no longer manufactured. The modeling engine 218 may query a warehouse 110 through the inventory management engine 202 for updated item information on these identified items.

Additionally, the modeling engine 218 maintains a trained purchase model that outputs a probability of the user purchasing an item. The trained purchase model accounts for times when the user previously purchased an item, such as a relative time from a previously received order including the item to a time when the model is applied, as well as attributes of the item (e.g., a type of the item, a quantity or an amount of the item that was previously purchased, a brand of the item). The trained purchase model may include a decay constant that decreases a weighting of purchases of the items over time, so purchases of the item at longer time intervals from the time when the trained purchase model is applied have lower weights than weights of purchases at the item at shorter time intervals from the time when the trained purchase model is applied. Additionally, the trained purchase model accounts for a frequency with which the user purchases an item, which increases a likelihood of the user purchasing an item if the user more frequently purchases the item. Other example factors used by the trained purchase model to determine the likelihood of a user purchasing an item include: a time interval between prior orders including the item received from the user, a frequency with which the item is included in prior orders received from the user, times when orders including the item were previously received from the user, preferences of the user, and any other suitable information. The trained purchase model may be trained using any suitable method or combination of methods (e.g., supervised learning, unsupervised learning, semi-supervised learning, etc.).

### Machine Learning Factors

The training datasets 220 include a time associated with previous delivery orders. In some embodiments, the training datasets 220 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 220 include a day of the week previous delivery orders were placed. The day of the week may impact item availability, since popular shopping days may have reduced inventory of items or restocking shipments may be received on particular days. In some embodiments, training datasets 220 include a time interval since an item was previously picked in a previously delivery order. If an item has recently been picked at a warehouse, this may increase the probability that it is still available. If there has been a long time interval since an item has been picked, this may indicate that the probability that it is available for subsequent orders is low or uncertain. In some embodiments, training datasets 220 include a time interval since an item was not found in a previous delivery order. If there has been a short time interval since an item was not found, this may indicate that there is a low probability that the item is available in subsequent delivery orders. And conversely, if there is has been a long time interval since an item was not found, this may indicate that the item may have been restocked and is available for subsequent delivery orders. In some examples, training datasets 220 may also include a rate at which an item is typically found by a shopper at a warehouse, a number of days since inventory information about the item was last received from the inventory management engine 202, a number of times an item was not found in a previous week, or any number of additional rate or time information. The relationships between this time information and item availability are determined by the modeling engine 218 training a machine learning model with the training datasets 220, producing the machine-learned item availability model 216.

The training datasets 220 include item characteristics. In some examples, the item characteristics include a department associated with the item. For example, if the item is yogurt, it is associated with the dairy department. The department may be the bakery, beverage, nonfood and pharmacy, produce and floral, deli, prepared foods, meat, seafood, dairy, the meat department, or dairy department, or any other categorization of items used by the warehouse. The department associated with an item may affect item availability, since different departments have different item turnover rates and inventory levels. In some examples, the item characteristics include an aisle of the warehouse associated with the item. The aisle of the warehouse may affect item availability, since different aisles of a warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 202. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others or may have larger inventories in the warehouses. In some examples, the item characteristics may include a number of times a shopper was instructed to keep looking for the item after he or she was initially unable to find the item, a total number of delivery orders received for the item, whether or not the product is organic, vegan, gluten free, or any other characteristics associated with an item. The relationships between item characteristics and item availability are determined by the modeling engine 218 training a machine learning model with the training datasets 220, producing the machine-learned item availability model 216.

The training datasets 220 may include additional item characteristics that affect the item availability and can therefore be used to build the machine-learned item availability model 216 relating the delivery order for an item to its predicted availability. The training datasets 220 may be periodically updated with recent previous delivery orders. The training datasets 220 may be updated with item availability information provided directly from shoppers 108. Following updating of the training datasets 220, a modeling engine 218 may retrain a model with the updated training datasets 220 and produce a new machine-learned item availability model 216.

### Customer Mobile Application

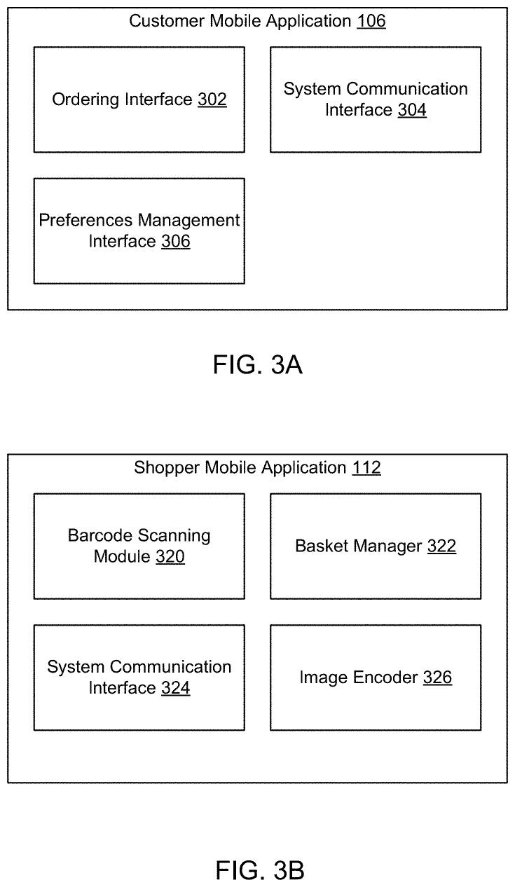

FIG. 3A is a diagram of the customer mobile application (CMA) 106, according to one embodiment. The CMA 106 includes an ordering interface 302, which provides an interactive interface with which the user 104 can browse through and select products and place an order. The CMA 106 also includes a system communication interface 304 which, among other functions, receives inventory information from the online shopping concierge system 102 and transmits order information to the system 102. The CMA 106 also includes a preferences management interface 306 which allows the user 104 to manage basic information associated with his/her account, such as his/her home address and payment instruments. The preferences management interface 306 may also allow the user to manage other details such as his/her favorite or preferred warehouses 110, preferred delivery times, special instructions for delivery, and so on.

### Shopper Mobile Application

FIG. 3B is a diagram of the shopper mobile application (SMA) 112, according to one embodiment. The SMA 112 includes a barcode scanning module 320 which allows a shopper 108 to scan an item at a warehouse 110 (such as a can of soup on the shelf at a grocery store). The barcode scanning module 320 may also include an interface which allows the shopper 108 to manually enter information describing an item (such as its serial number, SKU, quantity and/or weight) if a barcode is not available to be scanned. SMA 112 also includes a basket manager 322 which maintains a running record of items collected by the shopper 108 for purchase at a warehouse 110. This running record of items is commonly known as a “basket”. In one embodiment, the barcode scanning module 320 transmits information describing each item (such as its cost, quantity, weight, etc.) to the basket manager 322, which updates its basket accordingly. The SMA 112 also includes a system communication interface 324 which interacts with the online shopping concierge system 102. For example, the system communication interface 324 receives an order from the system 102 and transmits the contents of a basket of items to the system 102. The SMA 112 also includes an image encoder 326 which encodes the contents of a basket into an image. For example, the image encoder 326 may encode a basket of goods (with an identification of each item) into a QR code which can then be scanned by an employee of the warehouse 110 at check-out.

### Selecting an Interface for User Specification of a Quantity of an Item for Purchase

FIG. 4 is a flowchart of one embodiment of a method for an online concierge system 102 selecting an interface for a user to specify a quantity of an item for inclusion in an order. In various embodiments, the method includes different or additional steps than those described in conjunction with FIG. 4. Further, in some embodiments, the steps of the method may be performed in different orders than the order described in conjunction with FIG. 4. The method described in conjunction with FIG. 4 may be carried out by the online concierge system 102 in various embodiments.

The online concierge system 102 obtains 405 information about an item offered by a warehouse 110. In various embodiments, the online concierge system 102 receives a set of information about the item from the warehouse 110 and maintains additional information associated with the item determined by the online concierge system 102. This allows the online concierge system 102 to combine descriptive information about the item from a warehouse with additional information generated by the online concierge system 102 about the item, such as information generated from prior purchases of the item by the users of the online concierge system 102. In various embodiments, the information about the item includes quantity selection information for the item. A portion of the quantity selection information may be provided by the warehouse 110 from which the item is to be obtained, while one or more other portions of the quantity selection information is generated by the online concierge system 102 from prior purchases of the item, as further described below. In some embodiments, the online concierge system 102 obtains 405 the information about the item in response to a user selecting a warehouse 110 for an order, with the information about the item included in an item catalog of items offered by the warehouse 110 for purchase. In other embodiments, the online concierge system 102 obtains 405 the information about the item when the user selects the item after selecting a warehouse 110 from which one or more items of an order are to be purchased.

To allow a user to more easily specify a quantity of the item to be purchased for an order, the online concierge system 102 uses quantity selection information for the item to select an interface for presentation to the user. The online concierge system 102 maintains different interfaces for different quantity selection information, allowing different interfaces displaying different units of measurement for specifying a quantity of the item for inclusion in an order based on quantity selection information for the item. Such selection of a unit or measurement-specific interface for including the item in an order prevents confusion or ambiguity by a user when identifying a quantity of the item for inclusion in an order, while simplifying selection of a quantity by preventing the user from providing both a quantity of the item for inclusion in the order and a unit of measurement for the quantity.

The online concierge system 102 determines 410 whether quantity selection information obtained 405 for the item specifies a cost per unit for the item. In various embodiments, the quantity selection information includes a specific value if a cost per unit is specified for the item and includes an alternative value if a cost per weight is specified for the item. A warehouse 110 from which the item is obtained (e.g., a warehouse 110 selected by the user for an order) includes the specific value in the obtained information for the item in various embodiments, allowing the warehouse 110 to indicate whether the item is priced per unit. In response to determining 410 that the quantity selection information for the item specifies a cost per unit for the item, the online concierge system 102 configures an interface to display information describing the item and configures a selection element of the interface to receive a number of the item to include in an order. To simplify specification of the quantity of the item, the selection element is configured to receive only a unit of measurement corresponding to a number of items in various embodiments, removing ambiguity for the user about the unit of measurement used to specify the quantity of the item. The online concierge system 102 transmits 415 the interface with the configured selection element to a client device of the user for display.

FIG. 5 shows an example interface 500 configured to receive a number of an item for display to a user via a client device. In various embodiments, the interface 500 is displayed to a user via a customer mobile application 106 executing on a client device of the user. The interface 500 displays a description 505 of the item. In various embodiments, the description 505 includes an image of the item, a name of the item, a description of the item, as well as any additional suitable information.

Additionally, the per item interface 500 displays selection element 510 and a price per item 515. By interacting with the selection element 510, a user increases or decreases a number of the item that are included in the order. For the interface 500, the selection element 510 allows the user to modify a number of the item selected but does not allow the user to modify or specify an alternative unit of measurement for a quantity of the item. The price per item 515 includes a price for an individual item as well as an indication that the price corresponds to an individual item, such as text specifying “each” or specifying “per item.” However, in other embodiments, the price per item 515 includes any suitable designation or indication that the price corresponds to an individual item. Additionally, the interface 500 displays an estimation indication 520 proximate to the price per item 515 if the online concierge system 102 displays a par weight computed for the item, as further described below in conjunction with FIG. 4, rather than a price per item obtained from a warehouse 110 from which the item is to be obtained for an order. This allows the interface 500 to indicate to the user when the displayed price per item 515 is an approximation determined by the online concierge system 102. If the price per item is obtained from the warehouse 110 from which the item is to be obtained for the order, the interface 500 does not display the estimation indication 520 in conjunction with the price per item 515.

Referring back to FIG. 4, in response to determining 410 that that the quantity selection information for the item specifies a cost per weight for the item, the online concierge system 102 determines 420 whether the item is an item limited to being sold by weight. To determine 420 whether the item is limited to being sold by weight, the online concierge system 102 maintains a set of items for sale by weight only and compares an identifier of the item to identifiers of items of the set. In various embodiments, the set of items for sale by weight only is generated from manual review of items offered for sale and identification of items for which it is impractical to sell using a unit of measurement other than weight. Alternatively, the online concierge system 102 may generate the set from prior purchases of items, with items for which at least a threshold percentage of prior orders for the item specified a quantity of the item using weight. The online concierge system 102 may maintain different sets of items for sale by weight only for different warehouses 110 and may include items in a set of items for sale by weight only for a warehouse 110 based on information identifying the items from the warehouse 110.

In response to determining 420 that the item is limited to being sold by weight from the quantity selection information for the item, the online concierge system 102 configures an interface to include information describing the item and configures a selection element of the interface to receive a weight of the item to include in an order. To simplify specification of the quantity of the item, the selection element of the interface is configured to include only a unit of measurement corresponding to a weight of items in various embodiments, removing ambiguity for the user about the unit of measurement used to specify the quantity of the item. The online concierge system 102 transmits 425 the interface with the selected configuration of the selection interface to a client device of the user for display.

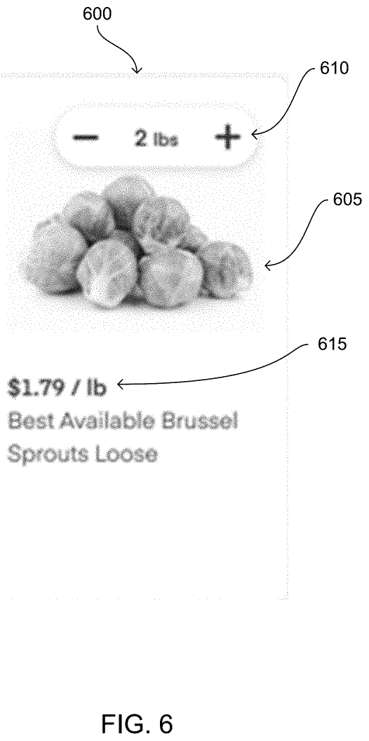

FIG. 6 shows an example interface 600 configured to receive a weight of an item for display to a user via a client device. In various embodiments, the interface 600 is displayed to a user via a customer mobile application 106 executing on a client device of the user. The interface 600 displays a description 605 of the item. In various embodiments, the description 605 includes an image of the item, a name of the item, a description of the item, as well as any additional suitable information.

Additionally, the per weight interface 600 displays a selection element 610 and a price per unit of weight 615. By interacting with the selection element 610, a user increases or decreases a weight of the item that included in the order. For the interface 600, the selection element 610 allows the user to modify a weight of the item selected but does not allow the user to modify or specify an alternative unit of measurement for a quantity of the item. The price per unit of weight 615 includes a price for a unit of weight for the item, such as a price per pound or a price per ounce. an individual item as well as an indication that the price corresponds to a unit of weight, such as text specifying “per pound” or “per ounce.” However, in other embodiments, the price per unit weight 615 includes any suitable designation or indication that the price corresponds to an individual item.

Referring back to FIG. 4, in response to determining 420 that the item is not limited to being sold by weight, the online concierge system 102 determines 430 whether a par weight for the item is included in the quantity selection information for the item. The par weight is determined from previously fulfilled orders for the item and specifies a weight of a single item from previously purchased numbers of items and weights corresponding to the previously purchased numbers of item; hence, the par weight provides a weight per individual item from fulfillment of orders identifying the item. The online concierge system 102 determines a par weight for the item from previously fulfilled orders for the item. When an order identifies an item and a weight of the item to purchase, when a shopper fulfills the order, the online concierge system 102 requests the shopper identify the weight of the item that was obtained by the shopper and a number of the items that were obtained by the shopper. For example, the online concierge system 102 transmits a prompt to a client device of the shopper to identify a number of the item that were obtained when fulfilling the order via the shopper mobile application 112 and transmits an additional prompt to the client device of the shopper to identify a weight of the item that was obtained when fulfilling the order via the shopper mobile application 112. The online concierge system 102 determines the par weight for the item for a fulfilled order by dividing the weight of the item obtained when fulfilling the order by the number of items obtained when fulfilling the order. The par weight of the item is determined from a set of fulfilled orders for which the item was obtained; for example, the online concierge system 102 determines the par weight of the item from par weights for the item for each of a set of orders fulfilled within a threshold amount of a current time determines the par weight for the item from par weights for the item for each of a threshold number of orders received within a threshold amount of time from a current time. This allows the online concierge system 102 to dynamically update the par weight for the item as the item is purchased over time. In various embodiments, the online concierge system 102 determines a par weight for a combination of the item and a warehouse 110 based on prior fulfillment of orders including the item from the warehouse 110, as further described above, allowing the online concierge system 120 to maintain different par weights for the item corresponding to different warehouses 110. Alternatively, the warehouse 110 transmits a specific par weight for the item to the online concierge system 102 for storage in association with a combination of the item and the warehouse 110; the warehouse 110 may transmit the specific par weight for the item at periodic intervals in various embodiments.

In response to determining 430 that a par weight is not stored for the item, the online concierge system 102 configures the selection element of the interface to receive a weight of the item to include in an order. The online concierge system 102 transmits 425 the interface with the selection element configured to receive a weight of the item to a client device of the user for display. FIG. 6, further described above, shows an example of the interface with the selection element configured to receive the weight of the item.

However, in response to determining 430 that a par weight is stored for the item, the online concierge system 102 determines 435 whether the item is offered in a package including one or more items. Whether the item is offered in a package is based on prior orders from data determined from previously fulfilled orders in which the item was obtained and stored in association with the item. In various embodiments, the online concierge system 102 prompts a shopper who obtained the item for an order to indicate whether the item was included in a package through the shopper mobile application 112. This allows the online concierge system 102 to account for purchases of the item by shoppers to determine if the item is included in a package. In various embodiments, the online concierge system 102 stores a package value in association with the item in response to receiving an indication that the item was included in a package from in a threshold number of previously fulfilled orders including the item. For example, the online concierge system 102 stores an indication the item is included in a package if at least a threshold percentage of orders fulfilled within a threshold amount of a current time include an indication from a shopper that the item was included in a package. In some embodiments, the online concierge system 102 stores an indication the item is included in a package in association with the item and with a warehouse 110, allowing the online concierge system 102 to maintain different indications of the item being included in a package, determined as further described above, for different warehouses 110, allowing the online concierge system to account for potential differences in packaging of the item by different warehouses 110. In some embodiments, the online concierge system 102 stores an alternative value in association with the item indicating the item is not included in a package in response to receiving a threshold number, or a threshold amount, of indications from shoppers fulfilling orders that the item is not included in a package; for example, in response to receiving an indication from shoppers for a threshold number of previously fulfilled orders including the item that the item is not included in a package, the online concierge system 102 stores the alternative value indicating the item is not included in a package in association with the item. In some embodiments, the online concierge system 102 does not store a value indicating whether the item is included in a package when less than the threshold number or amount of indications whether the item is included in a package are received from shoppers fulfilling orders including the item, so the online concierge system 102 does not maintain an indication whether the item is included in a package until receiving a minimum number of indications from shoppers whether the item is included in a package in some embodiments.

In response to determining 435 that the item is included in a package (e.g., determining 435 that a value indicating the item is included in a package is stored in association with the item from the obtained information), the online concierge system 102 configures an interface to display information describing the item and configures a selection element of the interface to receive a number of packages of the item to include in an order. To simplify specification of the quantity of the item, the selection element of the interface includes only a unit of measurement corresponding to a number of packages of the item in various embodiments, removing ambiguity for the user about the unit of measurement used to specify the quantity of the item. The online concierge system 102 transmits 440 the interface with the selection element configured to receive the number of packages to a client device of the user for display.

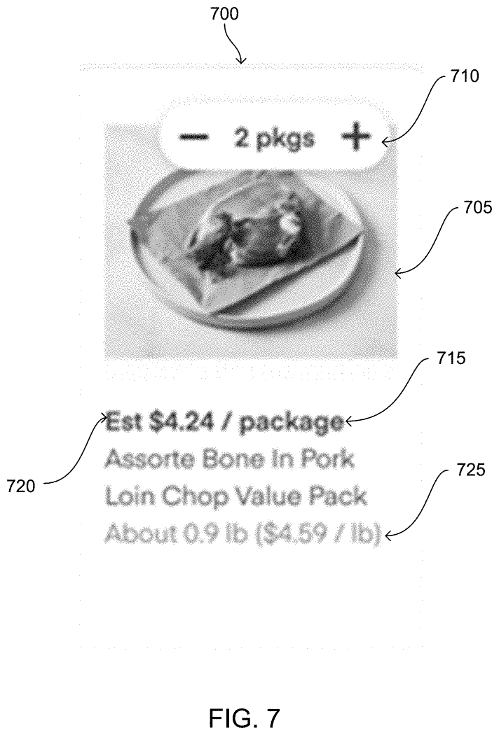

FIG. 7 shows an example interface 700 configured to receive a number of packages of an item. In various embodiments, the interface 700 is displayed to a user via a customer mobile application 106 executing on a client device of the user. The interface 700 displays a description 705 of the item. In various embodiments, the description 705 includes an image of the item, a name of the item, a description of the item, as well as any additional suitable information.

Additionally, the interface 700 displays a selection element 710 and a price per package 715. By interacting with the selection element 710, a user increases or decreases a number of packages of the item that are included in the order. For the interface 700, the selection element 710 allows the user to modify a number of packages of the item selected but does not allow the user to modify or specify an alternative unit of measurement for a quantity of the item. The price per package 715 includes a price for a package of the item, rather than for an individual item or a price per unit weight of the item, allowing the per package interface 700 to account for items that are prepackaged. Additionally, the price per package 715 displays an indication that the price corresponds to a package of the item, such as text specifying “per package.” However, in other embodiments, the price per package 715 includes any suitable designation or indication that the price corresponds to a package of the item individual item.

Additionally, the interface 700 displays an estimation indication 720 proximate to the price per item 715 if the online concierge system 102 determines the price per package of the item from a par weight of the item that the online concierge system 102 determined as further described above in conjunction with FIG. 4, rather than a price per package of the item obtained from a warehouse 110 from which the item is to be obtained for an order. This allows the interface 700 to indicate to the user when the displayed price per package 715 is an approximation determined by the online concierge system 102. If the price per item is obtained from the warehouse 110 from which the item is to be obtained for the order, the interface 700 does not display the estimation indication 720 in conjunction with the price per package 715. In some embodiments, such as the example shown in FIG. 7, the interface 700 also displays the par weight 725 determined for the item and an estimated package weight 730 the package of the item, allowing the user to review information used by the online concierge system 102 to estimate the displayed price per package 715. The estimated package weight 730 may be determined by the online concierge system 102 from information obtained from shoppers who fulfilled previous orders including the item, such as through responses by the shoppers to a prompt requesting entry of a weight of the item purchased to fulfill a previous order.

Referring back to FIG. 4, in response to determining 435 that an alternative value indicating the item is not included in a package is stored in association with the item from the obtained information, the online concierge system retrieves and transmits 415 the per item interface to the client device of the user, allowing the user to specify a number of the item for inclusion in an order, as further described above. Hence, if the obtained information for the item indicates the item is not included in a package, the online concierge system 102 transmits 415 the per item interface for display to the user, allowing the user to specify a quantity of the item for inclusion in the order.

In response to determining 435 no value indicating whether the item is included in a package or is not included in a package, the online concierge system 102 determines 445 a category of the item from the obtained information for the item. In various embodiments, the online concierge system 102 associates a category with each item offered by a warehouse 110. The category may be specified by the warehouse 110 from which the item is to be obtained, while in some embodiments the online concierge system 102 maintains a mapping of categories identified by a warehouse 110 to categories maintained by the online concierge system 102 to provide standardization of categories for items across various warehouses 110. For each of at least a set of categories, the online concierge system 102 maintains an association between a category and a configuration of the selection element of the interface for specifying a quantity of an item associated with the category. For example, the online concierge system 102 stores an association between a category of produce and a configuration of the selection element to receive a number of an item, while the online concierge system 102 stores an association between a configuration of the selection element to receive a weight of the item. However, in other embodiments, the online concierge system 102 stores an association between any suitable configuration of a selection element of the interface and category. The stored association between a configuration of the selection element of the interface and a category of item allows the online concierge system 102 to specify a default configuration of the selection element for items having the category that is displayed when the online concierge system 102 does not maintain information associated with the item indicating whether the item is included in a package. The online concierge system 102 selects 450 a configuration of the selection element for the interface based on the category associated with the item and transmits the interface with the selected configuration of the selection element to a client device of the user for display. Hence, based on the category determined 445 for the item, the online concierge system 102 selects 450 a configuration of the selection element of the of the set consisting of: a configuration to receive a number of the item, a configuration to receive a weight of the item, and a configuration to receive a number of packages of the item. The online concierge system 102 transmits the interface with the selected configuration of the selection element to the client device of the user for display.

By selecting a selection element for an interface having a specific unit of measurement for specifying a quantity of the item, the online concierge system 102 mitigates potential confusion of the user in specifying a quantity of the item for inclusion in the order. Transmitting a specific selection element for an interface configured to receive a unit of measurement specific to an item allows the online concierge system 102 to simplify specification of a quantity of the item based on information about the item. Additionally, such a unit of measurement specific display for the item minimizes potential confusion for a user specifying a quantity of the item for inclusion in an order.

### ADDITIONAL CONSIDERATIONS

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
generating a user interface for selecting an amount of an item for purchase, the user interface including a selection element for specifying a quantity of the item;
obtaining, at an online concierge system, quantity selection information for an item offered by a warehouse;
determining that the quantity selection information for the item does not include a cost per unit for the item;
responsive to determining that the quantity selection information for the item does not include a cost per unit for the item, determining that the item is not limited to being sold by weight from the quantity selection information;
responsive to determining that the quantity selection information for the item does not include a cost per unit for the item and to determining that the item is not limited to being sold by weight from the quantity selection information, determining that quantity selection information includes a par weight for the item obtained by the online concierge system;
responsive to determining that quantity selection information includes the par weight for the item obtained by the online concierge system, configuring the selection element of the user interface to display the par weight of the item and to include a quantity selection region configured to receive a weight of the item; and
transmitting the user interface for display on a client device of a user.

2. The method of claim 1, wherein the par weight is determined by the online concierge system from previously fulfilled orders including the item.

3. The method of claim 2, wherein the par weight is determined by the online concierge system by:
identifying a set of previously fulfilled orders including the item;
for each previously fulfilled order of the set, retrieving a number of the item obtained and a weight of the item obtained; and
determining the par weight from the number of the item and the weight of the item obtained in each of the previously fulfilled order of the set.

4. The method of claim 2, wherein the set of previously fulfilled orders comprises a threshold number of orders received within a threshold amount of time from a current time.

5. The method of claim 2, wherein the per item interface displays an estimation indication in conjunction with the par weight, the estimation indication displaying that the par weight was determined by the online concierge system.

6. The method of claim 1, further comprising:
responsive to determining that quantity selection information does not include the par weight for the item obtained by the online concierge system:
determining that the item is included in a package; and
responsive to determining that the item is included in the package, configuring the selection element of the user interface to receive a number of packages of the item.

7. The method of claim 6, wherein determining that the item is included in the package comprises:
determining that at least a threshold percentage of previously orders include an indication from a shopper that the item was included in a package.

8. The method of claim 6, further comprising:
responsive to determining that quantity selection information does not include the par weight for the item obtained by the online concierge system:
determining that the item is not included in the package; and
responsive to determining that the item is included in the package, configuring the selection element of the user interface to receive a number of the item.

9. The method of claim 6, wherein determining that the item is included in the package comprises:
determining that at least a threshold number of previously fulfilled orders include an indication from a shopper that the item was not included in a package.

10. The method of claim 6, further comprising:
responsive to determining that quantity selection information does not include the par weight for the item obtained by the online concierge system:
determining that no indication whether the item is included in the package is stored in association with the item;
determining a category associated with the item by the online concierge system; and
selecting a configuration of the selection element of the interface based on the determined category; and
transmitting the interface with the selected configuration of the selection element to the client device of the user.

11. The method of claim 1, wherein determining that the item is not limited to being sold by weight from the quantity selection information comprises:
determining that the item is not included in a set of items for sale by weight only.

12. The method of claim 1, further comprising:
responsive to determining that the quantity selection information for the item does not include a cost per unit for the item, determining that the item not limited to being sold by weight from the quantity selection information; and
responsive to determining that the item not limited to being sold by weight from the quantity selection information, transmitting the interface to the client device of the user.

13. The method of claim 1, further comprising:
determining that the quantity selection information for the item includes the cost per unit for the item; and
responsive to determining that the quantity selection information for the item includes the cost per unit for the item, configure the selection element of the interface to receive a number of the item.

14. A computer program product comprising a non-transitory computer readable storage medium having instructions encoded thereon that, when executed by a processor, cause the processor to:
generate a user interface for selecting an amount of an item for purchase, the user interface including a selection element for specifying a quantity of the item;
obtain, at an online concierge system, quantity selection information for an item offered by a warehouse;
determine that the quantity selection information for the item does not include a cost per unit for the item;
responsive to determining that the quantity selection information for the item does not include a cost per unit for the item, determine that the item is not limited to being sold by weight from the quantity selection information;
responsive to determining that the quantity selection information for the item does not include a cost per unit for the item and to determining that the item is not limited to being sold by weight from the quantity selection information, determine that quantity selection information includes a par weight for the item obtained by the online concierge system; and
responsive to determining that quantity selection information includes the par weight for the item obtained by the online concierge system, configuring the selection element of the user interface to display the par weight of the item and to include a quantity selection region configured to receive a weight of the item; and
transmitting the user interface for display on a client device of a user.

15. The computer program product of claim 14, wherein the par weight is determined by the online concierge system from previously fulfilled orders including the item.

16. The computer program product of claim 15, wherein the par weight is determined by the online concierge system by:
identifying a set of previously fulfilled orders including the item;
for each previously fulfilled order of the set, retrieving a number of the item obtained and a weight of the item obtained; and
determining the par weight from the number of the item and the weight of the item obtained in each of the previously fulfilled order of the set.

17. The computer program product of claim 15, wherein the set of previously fulfilled orders comprises a threshold number of orders received within a threshold amount of time from a current time.

18. The computer program product of claim 15, wherein the per item interface displays an estimation indication in conjunction with the par weight, the estimation indication displaying that the par weight was determined by the online concierge system.

19. The computer program product of claim 14, wherein the non-transitory computer readable storage medium further has instructions encoded thereon that, when executed by the processor, cause the processor to:
responsive to determining that quantity selection information does not include the par weight for the item obtained by the online concierge system:
determine that the item is included in a package; and
responsive to determining that the item is included in the package, configuring the selection element of the interface configured to receive a number of packages of the item.

20. The computer program product of claim 19, wherein determine that the item is included in the package comprises:
determine that at least a threshold percentage of previously orders include an indication from a shopper that the item was included in a package.

21. The computer program product of claim 19, wherein the non-transitory computer readable storage medium further has instructions encoded thereon that, when executed by the processor, cause the processor to:
responsive to determining that quantity selection information does not include the par weight for the item obtained by the online concierge system:
determine that the item is not included in the package; and
responsive to determining that the item is included in the package, configure the selection element of the interface to receive a number of the item.

22. The computer program product of claim 19, wherein determine that the item is included in the package comprises:
determine that at least a threshold number of previously fulfilled orders include an indication from a shopper that the item was not included in a package.

23. The computer program product of claim 19, wherein the non-transitory computer readable storage medium has instructions encoded thereon that, when executed by the processor, cause the processor to:
responsive to determining that quantity selection information does not include the par weight for the item obtained by the online concierge system:
determine that no indication whether the item is included in the package is stored in association with the item;
determine a category associated with the item by the online concierge system; and
select a configuration of the selection element of the interface based on the determined category; and
transmit the interface with the selected configuration of the selection element to the client device of the user.

24. The computer program product of claim 14, wherein determine that the item is not limited to being sold by weight from the quantity selection information comprises:
determine that the item is not included in a set of items for sale by weight only.

25. The computer program product of claim 14, wherein the non-transitory computer readable storage medium further has instructions encoded thereon, that when executed by the processor, cause the processor to:
responsive to determining that the quantity selection information for the item does not include a cost per unit for the item, determine that the item not limited to being sold by weight from the quantity selection information; and
responsive to determining that the item not limited to being sold by weight from the quantity selection information, transmit the interface to the client device of the user.

26. The computer program product of claim 14, wherein the non-transitory computer readable storage medium further has instructions encoded thereon, that when executed by the processor, cause the processor to:
determine that the quantity selection information for the item includes the cost per unit for the item; and
responsive to determining that the quantity selection information for the item includes the cost per unit for the item, configure the selection element of the interface to receive a number of the item.
